(19) United States
(12) Patent Application Publication
(10) Pub. No.: US 2022/0281706 A1
(43) Pub. Date: Sep. 8, 2022

(54) CONVEYANCE DEVICE, LIQUID DISCHARGING APPARATUS, IMAGE FORMING APPARATUS, AND POST-PROCESSING APPARATUS

(71) Applicant: Ippei KIMURA, Kanagawa (JP)

(72) Inventor: Ippei KIMURA, Kanagawa (JP)

(21) Appl. No.: 17/572,655

(22) Filed: Jan. 11, 2022

(30) Foreign Application Priority Data
Mar. 8, 2021 (JP) 2021-036281

(51) Int. Cl. B65H 29/12; B41J 11/00

(52) U.S. Cl. CPC B65H 29/125; B41J 11/007; B65H 2801/06

(57) ABSTRACT

A conveyance device includes a plurality of pairs of rotators and a conveyance path. The pairs of rotators include first rotators disposed adjacent to a reverse side of a liquid-adhered surface of a sheet and second rotators disposed adjacent to the liquid-adhered surface. The second rotators have protrusions. Each pair of rotators includes one first rotator and two or more second rotators. The conveyance path includes at least one curved conveyance portion. The pairs of rotators are disposed at intervals on the conveyance path in a conveyance direction. The one first rotator and the two or more second rotators in at least one of the pairs are disposed in contact with each other. The number of the two or more second rotators arranged in a sheet width direction is larger in an upstream portion than in a downstream portion of the conveyance path in the conveyance direction.

### CROSS-REFERENCE TO RELATED APPLICATIONS

This patent application is based on and claims priority pursuant to 35 U.S.C. § 119(a) to Japanese Patent Application No. 2021-036281, filed on Mar. 8, 2021, in the Japan Patent Office, the entire disclosure of which is hereby incorporated by reference herein.

### BACKGROUND

### Technical Field

Embodiments of the present disclosure relate to a conveyance device, a liquid discharging apparatus, an image forming apparatus, and a post-processing apparatus.

### Related Art

An image forming apparatus, such as a copying machine or a printer, is known that includes a conveyance device that conveys a sheet to which liquid such as ink adheres.

For example, a configuration of such an image forming apparatus is known in which a sheet to which ink has adhered is conveyed while the sheet is sandwiched between a roller and a spur.

Using the spur whose contact area to the sheet is smaller than the contact area of the roller to the sheet allows to prevent deterioration of image quality due to disturbance of undried ink on the sheet.

### SUMMARY

In an embodiment of the present disclosure, a conveyance device includes a plurality of pairs of rotators and a conveyance path through which a sheet is conveyed. The plurality of pairs of rotators include a plurality of first rotators and a plurality of second rotators. The plurality of first rotators are disposed adjacent to a reverse side of a liquid-adhered surface of a sheet to which liquid is adhered. The plurality of second rotators are disposed adjacent to the liquid-adhered surface of the sheet. The plurality of second rotators have a plurality of protrusions that radially stick out. Each one of the plurality of pairs of rotators includes one of the plurality of first rotators and two or more of the plurality of second rotators. The conveyance path includes at least one curved conveyance portion. The plurality of pairs of rotators are disposed at intervals on the conveyance path in a conveyance direction. The one of the plurality of first rotators and the two or more of the plurality of second rotators in at least one of the plurality of pairs are disposed in contact with each other. The number of the two or more of the plurality of second rotators arranged in a sheet width direction perpendicular to the conveyance direction is larger in an upstream portion than in a downstream portion of the conveyance path in the conveyance direction.

In another embodiment of the present disclosure, a liquid discharging apparatus includes the conveyance device and a liquid discharger. The liquid discharger discharges liquid onto the sheet.

In still another embodiment of the present disclosure, an image forming apparatus includes the conveyance device and an image forming device. The image forming device discharges liquid onto the sheet to form an image.

In still another embodiment of the present disclosure, a post-processing apparatus includes the conveyance device and a post-processing device that performs post-processing to the sheet.

In still another embodiment of the present disclosure, a conveyance device includes a plurality of pairs of rotators and a conveyance path through which a sheet is conveyed. The plurality of pairs of rotators include a plurality of first rotators and a plurality of second rotators. The plurality of first rotators are disposed adjacent to a reverse side of a liquid-adhered surface of the sheet to which liquid is adhered. The plurality of second rotators are disposed adjacent to the liquid-adhered surface of the sheet. Each one of the plurality of second rotators has a plurality of protrusions that radially stick out. Each one of the plurality of pairs of rotators includes one of the plurality of first rotators and two or more of the plurality of second rotators. The conveyance path includes at least one curved conveyance portion. The plurality of pairs of rotators are disposed at intervals on the conveyance path in a conveyance direction. The one of the plurality of first rotators and the two or more of the plurality of second rotators in at least one of the plurality of pairs are spaced apart from each other in a sheet width direction perpendicular to the conveyance direction. The number of the two or more of the plurality of second rotators arranged in a sheet width direction perpendicular to the conveyance direction is larger in an upstream portion than in a downstream portion of the conveyance path in the conveyance direction.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram of an image forming apparatus according to an embodiment of the present disclosure;

FIG. 2 is a diagram illustrating a conveyance path that extends from an image forming device to a sheet output tray, according to an embodiment of the present disclosure;

FIG. 3 is a diagram illustrating a roller disposed on a support shaft, according to an embodiment of the present disclosure;

FIG. 4 is a diagram illustrating a plurality of rollers disposed on a support shaft, according to an alternative embodiment of the present disclosure;

FIG. 5 is a diagram illustrating a plurality of spurs disposed on a support shaft, according to an embodiment of the present disclosure;

FIG. 6 is a diagram illustrating groups of spurs in which a plurality of spurs arranged so as to be close to each other and disposed on a support shaft, according to an embodiment of the present disclosure;

FIG. 7 is a diagram illustrating three conveyors arranged on a conveyance path, according to a first embodiment of the present disclosure;

FIG. 8 is a diagram illustrating three conveyors arranged on a conveyance path, according to a second embodiment of the present disclosure;

FIG. 9 is a diagram illustrating three conveyors arranged on a conveyance path, according to a third embodiment of the present disclosure;

FIG. 10 is a diagram illustrating three conveyors arranged on a conveyance path, according to a fourth embodiment of the present disclosure;

FIG. 11 is a diagram illustrating three conveyors arranged on a conveyance path, according to a fifth embodiment of the present disclosure;

FIG. 12 is a diagram illustrating three conveyors arranged on a conveyance path in which the width of spurs disposed on a conveyor located most downstream is thickened, according to an alternative embodiment of the present disclosure;

FIG. 13 is a diagram illustrating a conveyance path on which a plurality of spurs are disposed and the number of protrusions of spurs disposed downstream in the conveyance path is increased, according to an embodiment of the present disclosure;

FIG. 14 is a diagram illustrating rollers disposed on a support shaft, and groups of spurs disposed on another support shaft in which the rollers are intermittently arranged about the support shaft in the axial direction of the support shaft, according to an embodiment of the present disclosure;

FIG. 15 is a diagram illustrating a roller disposed on a support shaft, in which the roller is continuously disposed on another support shaft in the axial direction of the support shaft, according to an embodiment of the present disclosure;

FIG. 16 is a diagram illustrating rollers disposed on a support shaft and groups of spurs disposed on another support shaft in which the rollers and the groups of spurs are arranged so as not to contact each other, according to an embodiment of the present disclosure;

FIG. 17 is a diagram illustrating rollers disposed on a support shaft and a group of spurs disposed on another support shaft in which the group of spurs enter an area between the rollers, according to an embodiment of the present disclosure;

FIG. 18 is a diagram illustrating rollers disposed on a support shaft and a group of spurs disposed on another support shaft in which the projecting amount of the spurs between the rollers changes in the axial direction of a support shaft, according to an embodiment of the present disclosure;

FIG. 19 is a diagram illustrating rollers and spurs in which the projecting amount of the spurs between the rollers changes in the axial direction of a support shaft, according to an embodiment of the present disclosure;

FIG. 20 is a diagram illustrating a conveyance path in which both pairs of a roller and a plurality of spurs that are in contact with each other and pairs of the roller and the spurs that are not in contact with each other are disposed, according to an embodiment of the present disclosure;

FIG. 21 is a diagram illustrating a plurality of spurs disposed on support shafts in which each of the multiple spurs disposed on one of the support shafts contacts a corresponding one of the spurs disposed on another support shaft via a sheet, according to an embodiment of the present disclosure;

FIG. 22 is a diagram illustrating a plurality of spurs disposed on support shafts in which the multiple spurs disposed on one of the support shafts does not contact the multiple spurs disposed on the other support shaft via a sheet, according to an embodiment of the present disclosure;

FIG. 23 is a diagram illustrating an image forming apparatus according to an alternative embodiment of the present disclosure;

FIG. 24 is a diagram illustrating an image forming apparatus according to a further alternative embodiment of the present disclosure;

FIG. 25 is a diagram illustrating a reverse conveyance path provided for an image forming apparatus, according to an alternative embodiment of the present disclosure;

FIG. 26 is a diagram illustrating a conveyance device provided for an image forming apparatus, according to an alternative embodiment of the present disclosure;

FIG. 27 is a schematic diagram of an image forming apparatus that includes a liquid discharging apparatus, according to an alternative embodiment of the present disclosure; and

FIG. 28 is a diagram illustrating a post-processing apparatus according to an alternative embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of the present disclosure are described with reference to the accompanying drawings. In the drawings, like reference signs denote like elements such as members and components having a like function or shape as long as the components can be distinguished from each other, and overlapping description may be omitted.

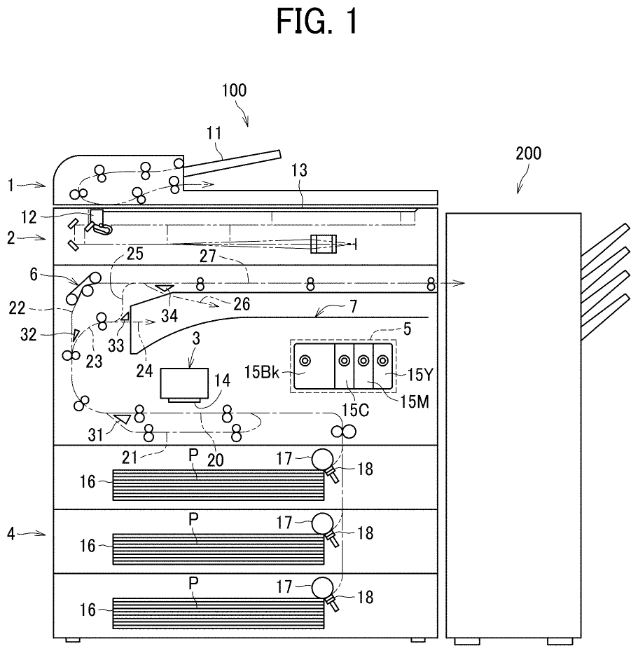

FIG. 1 is a schematic diagram of an image forming apparatus 100 according to an embodiment of the present disclosure.

As illustrated in FIG. 1, the image forming apparatus 100 according to the present embodiment includes a document conveyance device 1, an image reading device 2, an image forming device 3, a sheet feeder 4, a cartridge holder 5, a drying device 6 that serves as a heating device, and a sheet output tray 7. Next to the image forming apparatus 100, a sheet alignment apparatus 200 is disposed.

The document conveyance device 1 separates documents one by one from a document tray 11 and conveys the document toward an exposure glass 13 of the image reading device 2. The document conveyance device 1 includes a plurality of conveyance rollers that serve as document conveyors to convey the document.

The image reading device 2 reads an image of a document placed on the exposure glass 13 or an image of a document passing on the exposure glass 13. The image reading device 2 includes an optical scanning unit 12 that serves as an image reader. The optical scanning unit 12 includes a light source that irradiates the document on the exposure glass 13 with light, such as a charge-coupled device (CCD) that serves as an image reader and reads an image from reflected light of the document. As the image reader, for example, a contact image sensor (CIS) may be used.

The image forming device 3 includes a liquid discharge head 14 that discharges liquid ink onto a sheet as a liquid discharger. The liquid discharge head 14 may be a serial-type liquid discharge head that discharges ink while moving in a main scanning direction, i.e., a sheet width direction, of a sheet or a line-type liquid discharge head that discharges ink without moving a plurality of liquid discharge heads aligned in the main scanning direction.

Ink cartridges 15Y, 15M, 15C, and 15BK are detachably mounted on the cartridge holder 5. The ink cartridges 15Y, 15M, 15C, and 15BK are filled with ink of different colors such as yellow, magenta, cyan, and black, respectively. The ink in each one of the ink cartridges 15Y, 15M, 15C, and 15BK is supplied to the liquid discharge head 14 by a corresponding one of ink supply pumps.

The sheet feeder 4 includes a plurality of sheet trays 16 each functioning as a sheet container. Each one of the sheet trays 16 loads a bundle of sheets including a sheet P. Each sheet P on which an image is formed is a cut sheet cut in a predetermined size, e.g., A4 size or B4 size, and is previously contained in the sheet tray 16 in a corresponding sheet conveyance direction. Each one of the sheet trays 16 includes a sheet feed roller 17 as a sheet feeder and a sheet separation pad 18 as a sheet separator.

The drying device 6 includes a pair of heating rotating bodies that heat a sheet P while conveying the sheet P with the sheet P interposed between the heating rotating bodies. The heating source included in the drying device 6 may be an electromagnetic induction type heating source in addition to a radiant heat type heater that emits infrared rays such as a halogen heater or a carbon heater. The drying device 6 may be, for example, a hot air generating device that blows hot air to a sheet P to heat the sheet P.

The sheet alignment apparatus 200 functions as a post-processing apparatus to align and register sheets P conveyed from the image forming apparatus 100. In addition to the sheet alignment apparatus 200, another post-processing apparatus such as a stapling device that performs a binding process on sheets P or a punching device that punches holes in sheets P may be disposed.

With reference to FIG. 1, an operation of the image forming apparatus 100 according to the present embodiment is described below.

When an instruction is given to start a printing operation, a sheet P is fed from one sheet tray 16 of the multiple sheet trays 16. To be more specific, as the sheet feed roller 17 rotates, an uppermost sheet P placed on top of the bundle of sheets P contained in the sheet tray 16 is fed by the sheet feed roller 17 and the sheet separation pad 18 while the uppermost sheet P is separated from other sheets P of the bundle of sheets P.

When the sheet P is conveyed to a conveyance path 20 that extends in the horizontal direction and faces the image forming device 3, the image forming device 3 forms an image on the sheet P. To be more specific, the liquid discharge head 14 is controlled to discharge ink according to image data of the document read by the image reading device 2 or print data instructed to print by an external device, so that the ink is discharged on an upper face of the sheet P on which an image is formed to form an image. The image that has been formed on the sheet P may be a meaningful image such as a character or a graphic, or may be a meaningless pattern.

When duplex printing is performed, the sheet P is conveyed in a direction opposite to the sheet conveyance direction at a position downstream from the image forming device 3 in the sheet conveyance direction, so that the sheet P is guided to a reverse conveyance path 21. Specifically, after the trailing edge of the sheet P passes through a first path switching unit 31 disposed downstream from the image forming device 3 in the sheet conveyance direction, the conveyance path 20 is switched to the reverse conveyance path 21 by the first path switching unit 31, and the sheet P is conveyed in the direction opposite to the conveyance path 20. Accordingly, the sheet P is guided to the reverse conveyance path 21. Then, as the sheet P passes through the reverse conveyance path 21, the sheet P is reversed upside down and conveyed to the image forming device 3 again. Then, the image forming device 3 repeats the same operation described above to the back face of the sheet P, so as to form an image on the back face of the sheet P.

A second path switching unit 32 is disposed downstream from the first path switching unit 31 in the sheet conveyance direction. The second path switching unit 32 guides the sheet P on which the image has been formed selectively to a conveyance path 22 that runs through the drying device 6 or to a conveyance path 23 that does not run through the drying device 6. When the sheet P is guided to the conveyance path 22 through which the sheet P passes the drying device 6, the drying device 6 dries the ink on the sheet P. On the other hand, when the sheet P is guided to the conveyance path 23 that does not pass through the drying device 6, a third path switching unit 33 selectively guides the sheet P to a conveyance path 24 toward the sheet output tray 7 or a conveyance path 25 toward the sheet alignment apparatus 200. The sheet P that has passed through the drying device 6 is also selectively guided to a conveyance path 26 toward the sheet output tray 7 or a conveyance path 27 toward the sheet alignment apparatus 200 by another fourth path switching unit 34.

When the sheet P is guided to the conveyance path 24 or the conveyance path 26 toward the sheet output tray 7, the sheet P is ejected to the sheet output tray 7. On the other hand, when the sheet P is guided to the conveyance path 25 or the conveyance path 27 toward the sheet alignment apparatus 200, the sheet P is conveyed to the sheet alignment apparatus 200, so that the bundle of sheets P is aligned and stacked. Thus, a series of printing operations is completed. In the present embodiment, a so-called face-down sheet discharge method is employed in which the sheet P is sent to the sheet output tray 7 or the sheet alignment apparatus 200 with the surface of the sheet P on which an image is formed facing downward, which is a surface to which the ink has been attached in the case of single-sided printing.

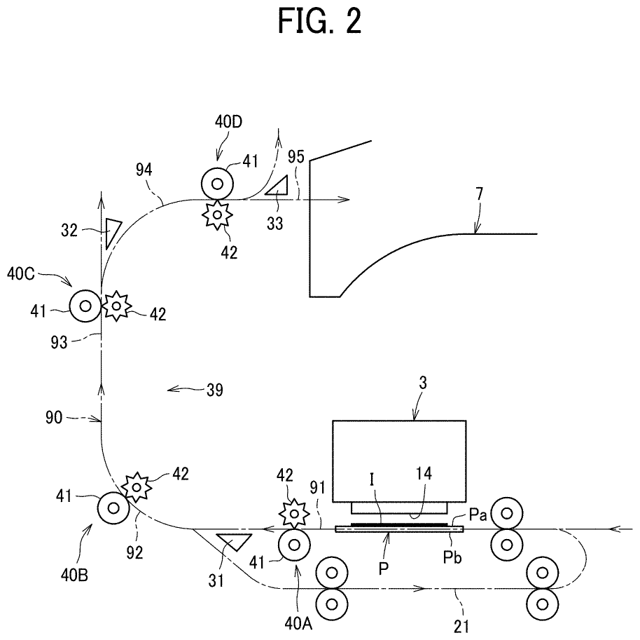

FIG. 2 is a diagram illustrating a conveyance path 90 that serves as a sheet conveyance path and extends from the image forming device 3 to the sheet output tray 7 as illustrated in FIG. 1.

In FIG. 2, each direction that is indicated by an arrow on a dashed line indicates a sheet conveyance direction in which the sheet P is conveyed.

As illustrated in FIG. 2, a conveyance device 39 that includes a plurality of rollers 41 and a plurality of spurs 42 is provided in the conveyance path 90 that extends from the image forming device 3 to the sheet output tray 7. Each of the rollers 41 and the corresponding one of the spurs 42 are pressed against each other by a biasing member such as a spring so that at least one of the rollers 41 or the corresponding one of the spurs 42 approaches the other. As described above, when the sheet P enters between the roller 41 and the spurs 42 which are in pressure contact with each other, the sheet P is conveyed while being nipped by the roller 41 which rotates and the spurs 42 which is driven to rotate. The spurs 42 may rotate instead of the roller 41.

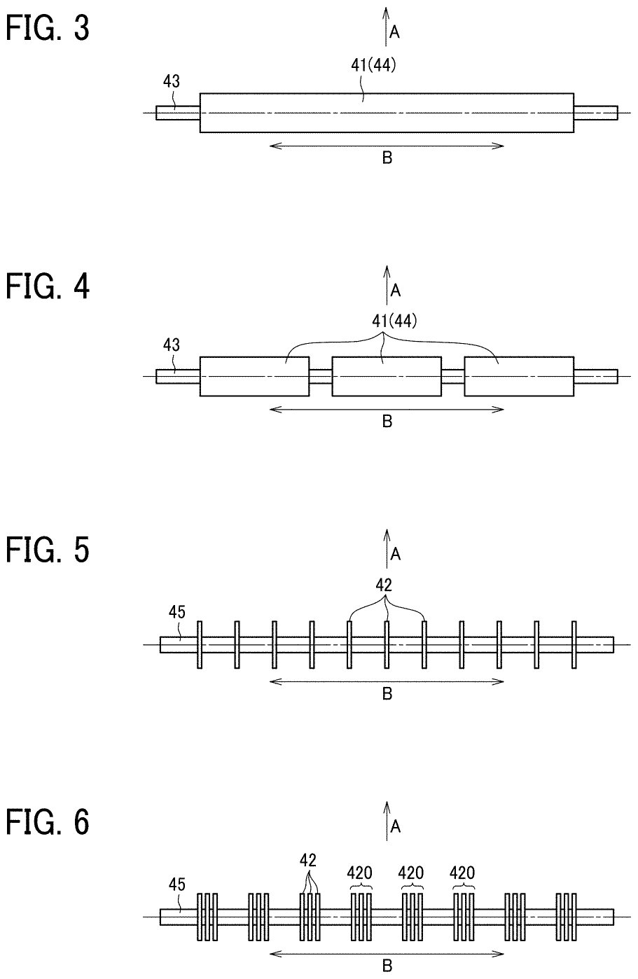

FIG. 3 is a diagram illustrating the roller 41 disposed on a support shaft 43, according to the present embodiment.

FIG. 4 is a diagram illustrating a plurality of rollers 41 disposed on the support shaft 43, according to the present embodiment.

As illustrated in FIG. 3, the roller 41 as a rotating body is a cylindrical elastic body 44 disposed on an outer peripheral surface of the support shaft 43. As the material of the elastic body 44, various elastic materials such as rubber can be applied. In particular, a material having good releasability from ink or a material having good water repellency is preferable. A coated layer made of a material having good releasability or water repellency may be disposed on an outer peripheral surface of the elastic body 44. The roller 41 may be arranged continuously in the axial direction of the support shaft 43 extending in a sheet width direction B orthogonal to a sheet conveyance direction A as in the embodiment illustrated in FIG. 3. Alternatively, the roller 41 may be arranged intermittently in the axial direction of the support shaft 43 as in the embodiment illustrated in FIG. 4.

FIG. 5 is a side view of a plurality of spurs 42 disposed on the support shaft 45, according to the present embodiment.

FIG. 6 is a diagram illustrating groups of spurs 42 in which a plurality of spurs 42 arranged so as to be close to each other and disposed on the support shaft 45, according to the present embodiment.

The spurs 42 are disc-shaped protrusion rotating body provided with a plurality of protrusions protruding in a direction of an outer diameter of the spurs 42. As illustrated in FIG. 5, the multiple spurs 42 are provided at intervals in the axial direction of the support shaft 45 that extends in the sheet width direction B. The spurs 42 may be arranged at equal intervals or at different intervals. As in the embodiment illustrated in FIG. 6, groups of spurs 420 in which the multiple spurs 42 are arranged so as to be close to each other may be disposed at equal intervals or at different intervals in the axial direction of the support shaft 45. The support shaft 45 may be a shaft that passes through all of the spurs 42, or may be a plurality of support shafts 45 that are individually provided for each one of the spurs 42 or each group of spurs 420.

In the present embodiment, assuming that the roller 41 and the multiple spurs 42 disposed at the same position in the sheet conveyance direction A serves as one conveyor, as illustrated in FIG. 2, four conveyors 40A, 40B, 40C, and 40D are disposed at intervals in the sheet conveyance direction on the conveyance path 90 from the image forming device 3 to the sheet output tray 7. The four conveyors 40A, 40B, 40C, and 40D are referred to as a first conveyor 40A, a second conveyor 40B, a third conveyor 40C, and a fourth conveyor 40D, respectively, in order from a portion of the conveyance path 90 close to the image forming device 3 in the following description. An upstream portion and a downstream portion of the conveyance path 90 in the sheet conveyance direction is referred to simply as upstream and downstream in the following description.

As illustrated in FIG. 2, in the conveyance path 90 according to the present embodiment, the first conveyor 40A, the second conveyor 40B, the third conveyor 40C, and the fourth conveyor 40D are disposed in a first horizontal conveyance portion 91, a first curved conveyance portion 92, a vertical conveyance portion 93, and a second horizontal conveyance portion 95, respectively. A second curved conveyance portion 94 is disposed between a vertical conveyance portion 93 and the second horizontal conveyance portion 95.

On the other hand, in a conveyance path upstream from the conveyance path 90 which is a conveyance path upstream from the image forming device 3, a plurality of conveyors including a pair of rollers 41 such as rubber rollers are disposed. For this reason, in the present embodiment, when a sheet P is sent out from the sheet feeder 4, the sheet P is conveyed to the image forming device 3 while being nipped by the roller pair.

Undried ink adheres to the sheet P immediately after an image is formed. For this reason, if the sheet P on which the image has been formed is conveyed by the roller pair, the ink on the sheet P may adhere to the roller 41. Thus, the image may be disturbed or the ink adhering to the roller 41 may adhere to the sheet P to be conveyed thereafter.

For this reason, in the present embodiment, the spurs 42 having a smaller contact area with the sheet P than the roller 41 are disposed on the conveyance path 90 along which the sheet P on which an image has been formed is conveyed. Thus, for example, disturbance of the image is prevented. In other words, as illustrated in FIG. 2, the spurs 42 are disposed on a liquid-adhered surface Pa of the sheet P on which ink I is adhered. Accordingly, even when the spurs 42 contact the liquid-adhered surface Pa of the sheet P, the ink I is less likely to adhere to the spurs 42. Thus, disturbance of the image during conveyance is prevented. Contamination of the subsequently conveyed paper can also be prevented. The liquid-adhered surface Pa is a surface, i.e., a front surface of the sheet P, to which the liquid, i.e., the ink adheres in the case of single-sided printing. The liquid-adhered surface Pa is a surface, i.e., a back surface of the sheet P to which the liquid, i.e., the ink adheres for the second time in the case of double-sided printing.

As described above, in the present embodiment, the spurs 42 are disposed on the liquid-adhered surface Pa of the sheet P. Thus, the sheet P can be conveyed while preventing disturbance of an image. On the other hand, the rollers 41 contact a surface Pb of the sheet P opposite to the liquid-adhered surface Pa. However, in the case of single-sided printing, ink does not adhere to the surface Pb opposite to the liquid-adhered surface Pa. Thus, there is no risk of ink adhering to the rollers 41.

In double-sided printing, after an image has been formed on the front surface of the sheet P, the sheet P is preferably conveyed to the drying device 6 (see FIG. 1) to dry the image or ink on the front surface. In this case, the sheet P that has gone through the drying process is preferably conveyed to the image forming device 3 again without passing through the drying device 6. Specifically, after the image on the front surface is dried, the sheet P is switched back and guided to the conveyance path 25 and the conveyance path 23 illustrated in FIG. 1. Then, the sheet P is guided to the image forming device 3 via the reverse conveyance path 21. The sheet P may be guided upstream on the conveyance path 22 from the drying device 6 via another conveyance path that bypasses the drying device 6, and the sheet P may be guided to the image forming device 3 via the reverse conveyance path 21. As described above, performing the drying process of an image on the front surface of the sheet P before an image is formed on the back surface of the sheet P allows the ink to be less likely to adhere to the rollers 41. Thus, decrease in image quality due to the contact of the rollers 41 can be prevented, even if the rollers 41 contact the image on the front surface of the sheet P after the image has been formed on the back surface of the sheet P.

However, even when the spurs 42 are used as the conveyors as in the present embodiment, there is a risk that contact marks of the spurs 42 may be formed on the liquid-adhered surface Pa or an image may be disturbed in a case in which it is difficult for ink to dry, for example, in a case in which the amount of ink adhered to a sheet P is large. The larger the contact pressure of the spurs 42 on the sheet P, the more likely the contact marks of the spurs 42 and the disturbance of the image are generated. Therefore, preferably to reduce the contact pressure of the spurs 42 to the sheet P to reduce the contact marks and prevent the disturbance of the image. However, when the contact pressure of the spurs 42 is reduced, a new disadvantage arises in that the conveyance force and the conveyance stability by the spurs 42 are reduced.

As a method of solving such a disadvantage, there is a method of increasing the number of spurs 42 arranged along the sheet width direction B to enhance the conveyance stability. When the number of spurs 42 arranged along the sheet width direction B is increased, the conveyance stability can be ensured even if the contact pressure of the spurs 42 is reduced. However, an increase in the number of the spurs 42 causes another disadvantage such as an increase in apparatus cost or an increase in assembly man-hours.

Accordingly, in the conveyance device 39 according to embodiments of the present disclosure, the following measures are taken to secure image quality and conveyance stability while preventing an increase in the number of spurs 42.

The configuration and operation of the conveyance device 39 according to each of the embodiments of the present disclosure is described in detail with reference to the drawings of the corresponding embodiments of the present disclosure in the following description.

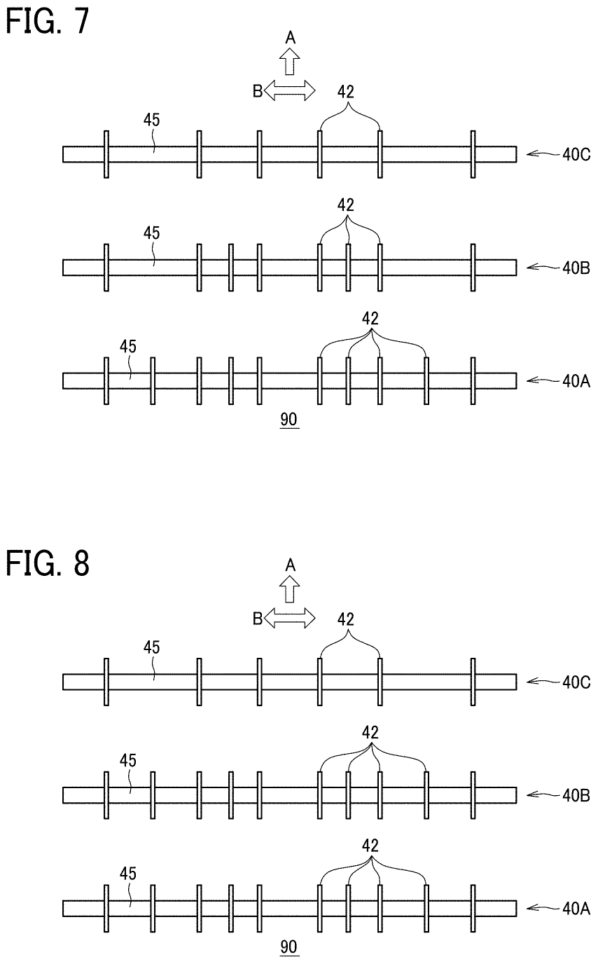

FIG. 7 is a diagram illustrating three conveyors 40A, 40B, and 40C arranged on the conveyance path 90 according to a first embodiment of the present disclosure.

In FIG. 7, only the spurs 42 provided for the three conveyors 40A, 40B, and 40C from the first to third conveyor counted from an upstream position of the conveyance path 90 are illustrated.

Immediately after ink is discharged and an image is formed, the sheet P is wet due to moisture of the ink. For this reason, there is a tendency that the contact marks of the spurs 42 and the disturbance of the image are more likely to occur in an upstream portion of the conveyance path 90 in which the drying of the ink does not progress. It is preferable that the contact pressure of the spurs 42 on the sheet P is reduced as described above to prevent such contact marks of the spurs 42 and disturbance of the image.

For this reason, in the first embodiment of the present disclosure, the contact pressure of the spurs 42 on the sheet P is reduced particularly in the upstream portion of the conveyance path 90 on which contact marks of the spur 42 and disturbance of the image are likely to occur. More specifically, assuming that contact Fa, Fb, and Fc denote the contact pressure between the rollers 41 and the spurs 42 of an upstream first conveyor 40A, the contact pressure between the rollers 41 and the spurs 42 of a midstream second conveyor 40B, and the contact pressure between the rollers 41 and the spurs 42 of a downstream third conveyor 40C, respectively, as illustrated in FIG. 7, the contact pressures Fa, Fb, and Fc are set to gradually decrease from a downstream portion to an upstream portion of the conveyance path 90 to satisfy a formula given below.

Fa<Fb<Fc

As described above, in the present embodiment, the contact pressures Fa, Fb, and Fc are set to gradually decrease from a downstream portion to an upstream portion of the conveyance path 90. Accordingly, the contact pressure of the spurs 42 applied to the sheet P is smaller in the upstream portion than in the downstream and midstream portion of the conveyance path 90. Thus, generation of contact marks of the spurs 42 and disturbance of the image can be prevented.

However, when the contact pressure of the spurs 42 in the upstream portion is reduced, the conveyance performance such as conveyance force and conveyance stability of the sheet P by the spurs 42 decreases. For this reason, in the present embodiment, the number of spurs 42 arranged in the sheet width direction B is greater in the upstream portion than in the downstream portion of the conveyance path 90, as illustrated in FIG. 7, to ensure the conveyance performance in the upstream portion. More specifically, in the present embodiment, when it is assumed that Ha, Hb, and He denote the numbers of spurs 42 of the upstream first conveyor 40A, the numbers of spurs 42 of the midstream second conveyor 40B, and the numbers of spurs 42 of the downstream third conveyor 40C, respectively, the numbers Ha, Hb, and He of spurs 42 are set to gradually increase from the downstream portion to the upstream portion of the conveyance path 90 to satisfy a formula given below.

Ha>Hb>Hc

As described above, in the present embodiment, the number of spurs 42 arranged in the sheet width direction B is greater in the upstream portion than in the downstream portion of the conveyance path 90. Thus, the conveyance performance in the upstream portion can be enhanced. Accordingly, even in the upstream portion in which the contact pressure of the spurs 42 is reduced, a sufficient conveyance force can be obtained. Thus, the sheet P is less likely to flap, and stable conveyance performance can be obtained. The spurs 42 in the upstream portion, the midstream portion, and the downstream portion, respectively, in the sheet width direction B may be at the same or corresponding positions or at different positions. The number of spurs 42 arranged in the sheet width direction B or the number of spurs 42 of each of the first conveyor 40A, the second conveyor 40B, and the third conveyor 40C are the number of spurs 42 disposed in a specific region defined by the width of the sheet P such as a maximum sheet passage width through which the sheet P having a maximum width passes. For this reason, a magnitude relation of the number of spurs 42 arranged in the sheet width direction B or of the number of spurs 42 in the embodiments of the present disclosure refers to a magnitude relation when the numbers of spurs 42 arranged in the same width region are compared.

On the other hand, in the midstream and the downstream portion of the conveyance path 90, the drying of the ink on the sheet P proceeds faster than in the upstream portion. For this reason, even if the contact pressure of the spurs 42 is increased, there is little possibility that contact marks of the spurs 42 are generated on the sheet P or an image on the sheet P is disturbed. Accordingly, in the midstream and the downstream portion, the contact pressure of the spurs 42 can be made larger than the contact pressure of the spurs 42 in the upstream portion to secure the conveyance performance. For this reason, the number of the spurs 42 can be reduced in the midstream and the downstream compared to the upstream.

As described above, in the present embodiment, a necessary number of spurs 42 are disposed as required in the upstream portion and the downstream portion, and in the midstream portion between the upstream portion and the downstream portion of the conveyance path 90. Such an arrangement as described above allows to ensure the image quality and the conveyance performance while preventing an increase in the number of spurs 42. In particular, the number of spurs 42 can be reduced in the midstream portion and the downstream portion compared to the upstream portion. Accordingly, the apparatus cost and assembly man-hours can be reduced.

Next, another embodiment different from the first embodiment is described below. Portions different from those of the first embodiment are mainly described. Other portions have basically the same configuration as in the first embodiment. Thus, description thereof is appropriately omitted in the following description.

FIG. 8 is a diagram illustrating the three conveyors 40A, 40B, and 40C arranged on the conveyance path 90, according to a second embodiment of the present disclosure.

As illustrated in FIG. 8, in the second embodiment of the present disclosure, among the upstream first conveyor 40A, the midstream second conveyor 40B, and the downstream third conveyor 40C, numbers Ha and Hb of spurs 42 of the upstream first conveyor 40A and midstream second conveyor 40B, respectively, are larger than number He of spurs 42 of the downstream third conveyor 40C and a following formula is obtained.

Ha>He

Hb>Hc

In the present embodiment, the number Ha of the spurs 42 of the upstream conveyor 40A and the number Hb of the spurs 42 of the midstream second conveyor 40B are the same and a following formula is obtained.

Ha=Hb

As described above, in the present embodiment, the number Ha of the spurs 42 of the upstream first conveyor 40A and the number Hb of the spurs 42 of the midstream second conveyor 40B are greater than the number He of the spurs 42 of the downstream third conveyor 40C. Thus, even when the contact pressures Fa and Fb between the rollers 41 and the spurs 42 of the upstream first conveyor 40A and of the midstream second conveyor 40B, respectively, are smaller than the contact pressure Fc between the rollers 41 and the spurs 42 of the downstream third conveyor 40C as in “Fa<Fc”, and “Fb<Fc”, the conveyance performance can be secured. Accordingly, generation of the contact marks of the spurs 42 and the disturbance of the image while ensuring the conveyance performance can be prevented in the upstream portion and the midstream portion of the conveyance path 90 in which the drying of the ink is less advanced than in the downstream portion. On the other hand, the number of spurs 42 can be reduced in the downstream portion. Thus, the apparatus cost and assembly man-hours can be reduced.

In the present embodiment, the numbers of the spurs 42 in the upstream portion and the midstream portion are the same. For this reason, the contact pressures Fa and Fb of the spurs 42 in the upstream portion and the midstream portion may also be set to the same value as in the formula given below.

Fa=Fb

The contact pressure Fa of the spurs 42 in the upstream portion may be smaller than the contact pressure Fb of the spurs 42 in the midstream portion as in the equation given below to effectively prevent the contact marks of the upstream spurs 42 and the disturbance of the image.

Fa<Fb

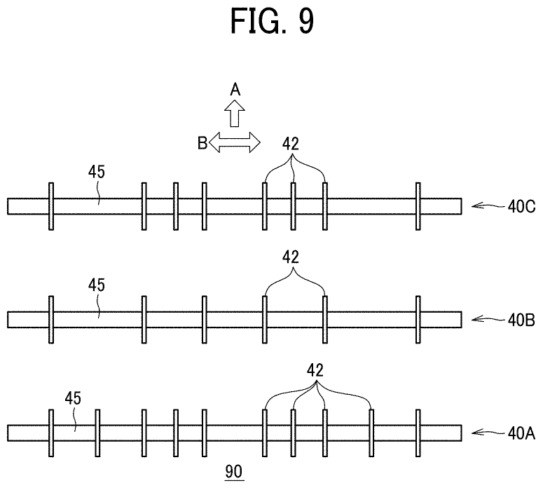

FIG. 9 is a diagram illustrating the three conveyors 40A, 40B, and 40C arranged on the conveyance path 90, according to a third embodiment of the present disclosure.

As illustrated in FIG. 9, in the third embodiment of the present disclosure, among the upstream first conveyor 40A, the midstream second conveyor 40B, and the downstream third conveyor 40C, the number Ha of spurs 42 of the upstream first conveyor 40A is larger than the number Hb of spurs 42 of the midstream second conveyor 40B and the number He of spurs 42 of the downstream conveyor 40C as in the formula given below.

Ha>Hb

Ha>He

As described above, in the present embodiment, the number Ha of spurs 42 of the upstream first conveyor 40A is larger than the numbers Hb of spurs 42 of the midstream second conveyor 40B and the number He of spurs 42 of the downstream conveyors 40C. Thus, even when the contact pressure Fa of the spurs 42 in the upstream portion is smaller than the contact pressure Fb of the spurs 42 in the midstream portion and the contact pressure Fc of the spurs 42 in the downstream portion as in the formula given below, the conveyance performance can be secured.

Fa<Fb

Fa<Fc

Accordingly, the contact marks of the spurs 42 and the disturbance of the image can be prevented while securing the conveyance performance in the upstream portion in which the drying of the ink has not progressed compared to the midstream and the downstream portion. On the other hand, the number of spurs 42 can be reduced in the midstream and the downstream portion. Thus, the apparatus cost and the assembly man-hours can be reduced.

However, in the present embodiment, unlike the above-described embodiments, the number Hb of the spurs 42 of the midstream second conveyor 40B is smaller than the number He of the spurs 42 of the downstream third conveyor 40C as in the formula given below.

Hb<He

In general, when the number of spurs 42 is reduced, the conveyance performance is likely to decrease. However, in the present embodiment, the midstream second conveyor 40B is disposed in the first curved conveyance portion 92 illustrated in FIG. 2. Thus, the contact pressure of the roller 41 on the sheet P is greater than the contact pressure of other conveyors disposed on a linear conveyance path. In other words, in the first curved conveyance portion 92 in which the midstream second conveyor 40B is disposed, the sheet P is pressed against the roller 41 by the restoring force that causes the bent sheet P to return to an original state. Thus, the contact pressure of the sheet P against the roller 41 increases. For this reason, in the midstream second conveyor 40B, the conveyance performance can be secured even if the number of spurs 42 is reduced.

As described above, in the midstream second conveyor 40B, the restoring force of the curved sheet P can ensure the conveyance performance. Thus, the number of spurs 42 can be reduced, and the apparatus cost and assembly man-hours can be reduced.

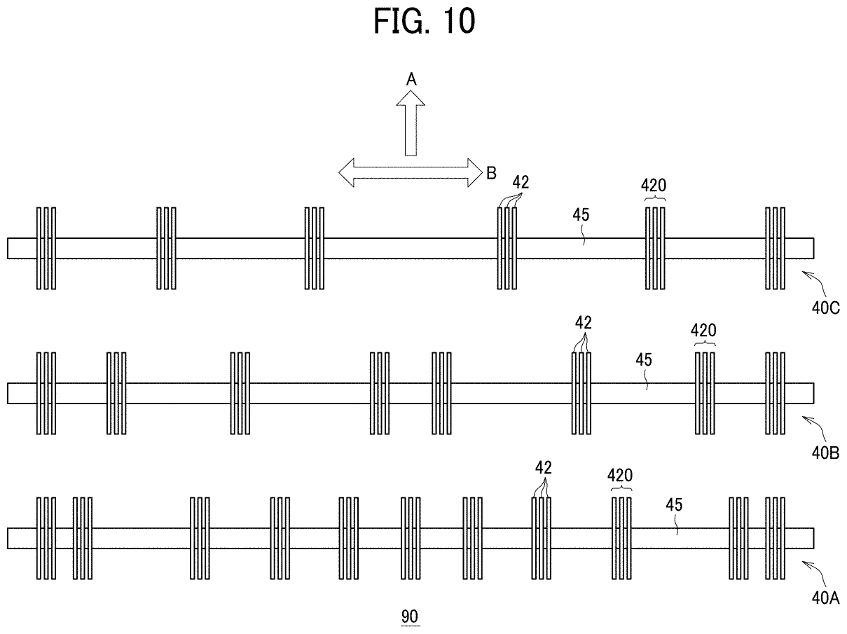

FIG. 10 is a diagram illustrating the first conveyor 40A, the second conveyor 40B, and the third conveyor 40C arranged on the conveyance path 90, according to a fourth embodiment of the present disclosure.

As illustrated in FIG. 10, in the fourth embodiment of the present disclosure, each of the upstream first conveyor 40A, the midstream second conveyor 40B, and the downstream third conveyor 40C includes the group of spurs 420 each of which includes the multiple spurs 42. In this case, each of the groups of spurs 420 includes the three spurs 42 arranged close to each other. In the present embodiment, the number of groups of spurs 420 included in each of the first conveyor 40A, the second conveyor 40B, and the third conveyor 40C gradually increases from a downstream portion to an upstream portion on the conveyance path 90. Accordingly, the number of the spurs 42 also increases gradually from the downstream to upstream on the conveyance path 90.

As described above, in the present embodiment, gradually increasing the number of the groups of spurs 420 from a downstream portion to an upstream portion on the conveyance path 90 causes particularly the number of the spurs 42 in the upstream portion of the conveyance path 90 to increase. Thus, even if the contact pressure of each one of the spurs 42 in the upstream portion is reduced, the contact marks of the spurs 42 and the disturbance of the image can be prevented while securing the conveyance performance. The number of spurs 42 can be reduced in the downstream portion. Accordingly, the apparatus cost and the assembly man-hours can be reduced.

In the present embodiment, the positions of the spurs 42 in the upstream, midstream, and downstream portion of the conveyance path 90 in the sheet width direction B are different from each other except for the groups of spurs 420 at both ends in the axial direction of the support shaft 45. As described above, the positions of the spurs 42 in the sheet width direction B are different in the upstream, midstream, and downstream portions of the conveyance path 90. Thus, positions at which the spurs 42 contact the sheet P are also different. Accordingly, the spurs 42 can be prevented from repeatedly contacting the same positions of the sheet P, i.e., overlapping positions in the sheet conveyance direction A. Such an arrangement as described above allows to effectively prevent the generation of contact marks of the spurs 42.

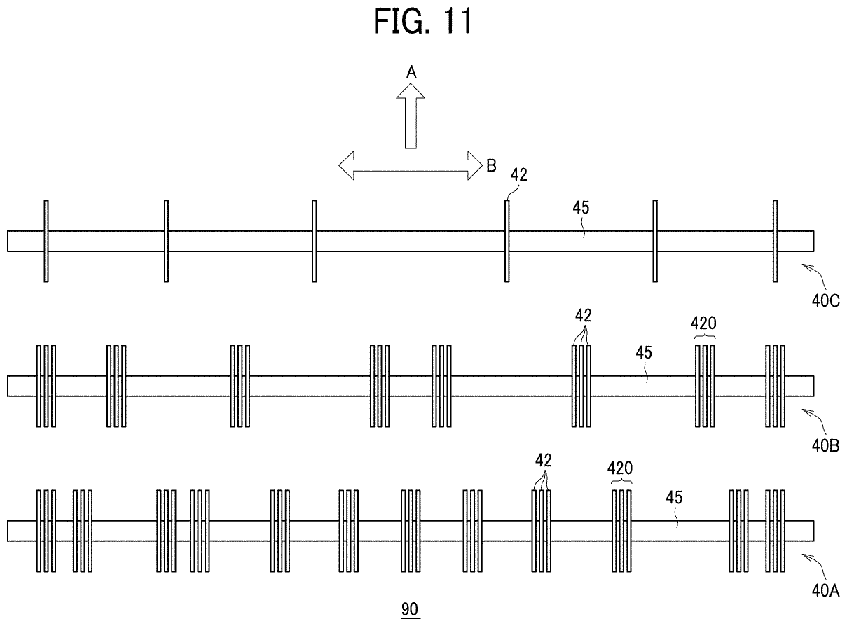

FIG. 11 is a diagram illustrating the first conveyor 40A, the second conveyor 40B, and the third conveyor 40C arranged on the conveyance path 90, according to a fifth embodiment of the present disclosure.

As illustrated in FIG. 11, in the fifth embodiment of the present disclosure, among the upstream first conveyor 40A, the midstream second conveyor 40B, and the downstream third conveyor 40C, only the downstream third conveyor 40C includes the multiple spurs 42 and does not include the groups of spurs 420. Each of the upstream first conveyor 40A and the midstream second conveyor 40B include the multiple groups of spurs 420.

As described above, each of the upstream first conveyor 40A, the midstream second conveyor 40B, and the downstream third conveyor 40C may not include the groups of spurs 420, or may include the groups of spurs 420. Also in the present embodiment, the number of spurs 42 arranged in the sheet width direction B gradually increases from a downstream portion to an upstream portion. Accordingly, the contact pressure of each of the spurs 42 can be reduced particularly in the upstream portion, and the contact marks of the spurs 42 and the disturbance of the image can be prevented while securing the conveyance performance. The number of spurs 42 can be reduced in the downstream portion. Accordingly, the apparatus cost and the assembly man-hours can be reduced. The conveyor that does not include the group of spurs 420 is not limited to the downstream third conveyor 40C, and may be the midstream second conveyor 40B or the upstream first conveyor 40A.

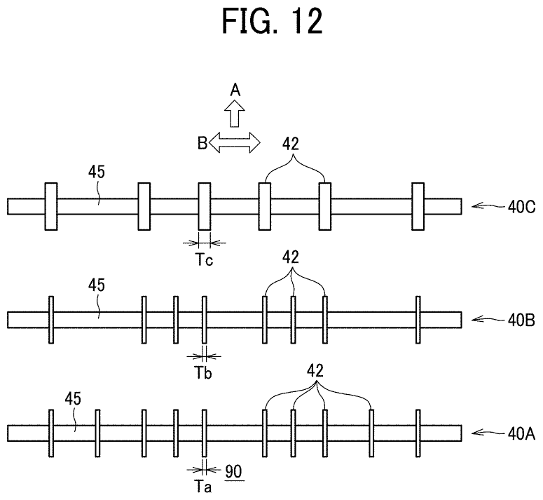

FIG. 12 is a diagram illustrating the upstream first conveyor 40A, the midstream second conveyor 40B, and the downstream third conveyor 40C arranged on the conveyance path 90 in which the width of spurs 42 disposed on the downstream third conveyor 40C is thickened, according to an alternative embodiment of the present disclosure.

The spurs 42 that are included in each of the upstream first conveyor 40A, the midstream second conveyor 40B, and the downstream third conveyor 40C may have a configuration as described below.

In the embodiment illustrated in FIG. 12, the width of the spurs 42 of the downstream third conveyor 40C is thicker in the axial direction, i.e., the sheet width direction B, than the width of the spurs 42 of the upstream first conveyor 40A, the midstream second conveyor 40B. As described above, making thickness Tc of the spurs 42 of the downstream third conveyor 40C in the axial direction, i.e., the sheet width direction B, thicker than the thicknesses Ta and Tb of the spurs 42 of the upstream first conveyor 40A and the midstream second conveyor 40B in the axial direction, i.e., the sheet width direction B, the contact area of the spurs 42 with respect to the sheet P increases in the sheet width direction B in the downstream portion of the conveyance path 90. Thus, the conveyance performance is enhanced. Accordingly, adopting the configuration as illustrated in FIG. 12 allows the conveyance performance to be enhanced. Thus, fluttering of the sheet P can be prevented and the sheet P can be conveyed more stably, even in the downstream portion in which the number of spurs 42 is smaller than that in the upstream portion and the midstream portion of the conveyance path 90. In addition to the spurs 42 of the downstream third conveyor 40C, the width of the spurs 42 of the midstream second conveyor 40B may be thicker than the spurs 42 of the upstream first conveyor 40A.

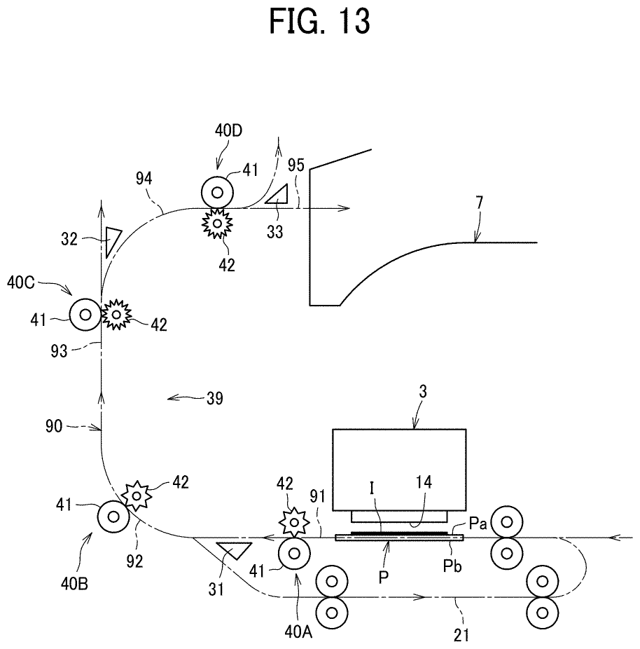

FIG. 13 is a diagram illustrating the conveyance path 90 on which the multiple spurs 42 are disposed and the number of protrusions of spurs 42 disposed downstream in the conveyance path 90 is increased, according to one of the above embodiments of the present disclosure.

In the embodiment illustrated in FIG. 13, the number of protrusions per unit rotation angle of each of the spurs 42 of the downstream third conveyor 40C is larger than the number of protrusions per unit rotation angle of each of the spurs 42 of the upstream first conveyor 40A and the midstream second conveyor 40B. As described above, the number of protrusions per unit rotation angle of the spurs 42 of the downstream third conveyor 40C is greater than the number of protrusions per unit rotation angle of the spurs 42 of the upstream first conveyor 40A and the midstream second conveyor 40B. Thus, the number of protrusions that contact the sheet P increases in the downstream portion. Accordingly, the conveyance performance is enhanced. Adopting the configuration as illustrated in FIG. 13 allows the conveyance performance to be enhanced even in the downstream portion in which the number of spurs 42 is smaller than in the upstream and the midstream portions. Thus, fluttering of the sheet P is prevented and the sheet P can be conveyed in a more stable manner. In addition to the spurs 42 of the downstream third conveyor 40C, the spurs 42 of the midstream second conveyor 40B may have a larger number of protrusions than the spurs 42 of the upstream first conveyor 40A.

In each of the above-described embodiments, the relation between the number of spurs 42 and the contact pressure of the spurs 42 of each of the three conveyors, i.e., the upstream first conveyor 40A, the midstream second conveyor 40B, and the downstream third conveyor 40C arranged on the conveyance path 90 has been described by way of example. However, the relation between the number of spurs 42 and the contact pressure of the spurs 42 described in the embodiments of the present disclosure may be established at least in two conveyors disposed relatively upstream and downstream. In other words, the number of the spurs 42 may be larger in midstream than in downstream, in upstream than in midstream, or in upstream than in downstream. The contact pressure of the spurs 42 may be smaller in midstream than in downstream, in upstream than in midstream, or in upstream than in downstream. Such a relation between the number of spurs 42 and the contact pressure of the spurs 42 as described above can be similarly applied to another conveyor, such as the fourth conveyor 40D disposed on the conveyance path 90.

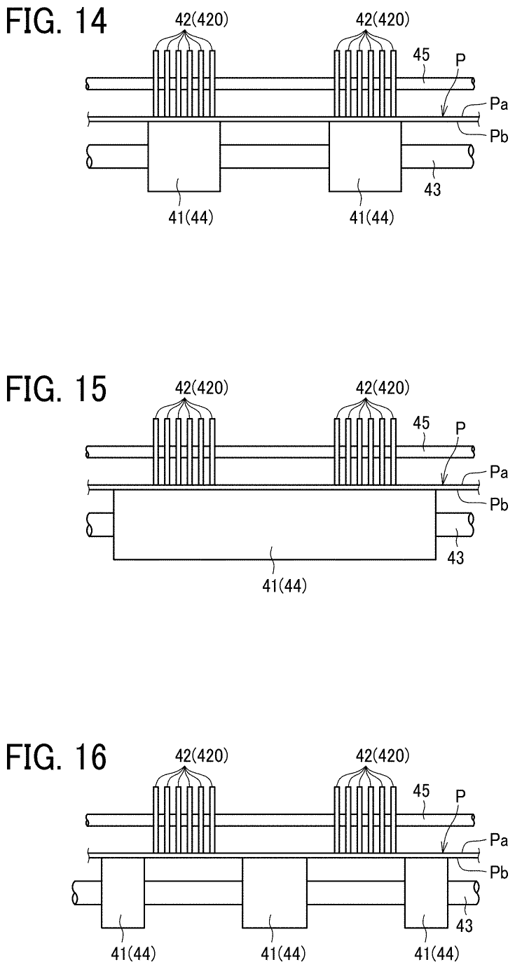

Alternatively, the conveyor may have a configuration as illustrated in FIGS. 14, 15, 16, 17, and 18 in addition to the configuration of the above-described embodiment.

FIG. 14 is a diagram illustrating the rollers 41 disposed on the support shaft 43 and groups of spurs 420 disposed on the support shaft 45, in which the rollers 41 are intermittently arranged on the support shaft 43 in the axial direction of the support shaft 43, according to one of the above embodiments of the present disclosure.

The conveyor illustrated in FIG. 14 includes a plurality of rollers 41 arranged intermittently in the axial direction and a plurality of groups of spurs 420 in contact with a corresponding one of the rollers 41.

FIG. 15 is a diagram illustrating the roller 41 disposed on the support shaft 43, in which the roller 41 is continuously disposed on the support shaft 43 in the axial direction of the support shaft 43, according to one of the above embodiments of the present disclosure.

The conveyor illustrated in FIG. 15 is different from the conveyor illustrated in FIG. 14 in that the roller 41 is disposed continuously over the multiple groups of spurs 420. In particular, in the case of the embodiment illustrated in FIG. 15, the range in which the roller 41 and the sheet P contact each other is increased. Thus, the conveyance performance is enhanced. For this reason, such a configuration as illustrated in FIG. 15 is preferably applied to an upstream conveyor in which the contact pressure of the spurs 42 against the sheet P is small.

FIG. 16 is a diagram illustrating the rollers 41 disposed on the support shaft 43 and groups of spurs 420 disposed on the support shaft 45 in which the rollers 41 and the groups of spurs 420 are arranged so as not to contact each other, according to one of the above embodiments of the present disclosure.

As in the embodiment illustrated in FIG. 16, the roller 41 and the groups of spurs 420 may be disposed so as to be shifted in the axial direction, i.e., the sheet width direction B, so as not to contact each other.

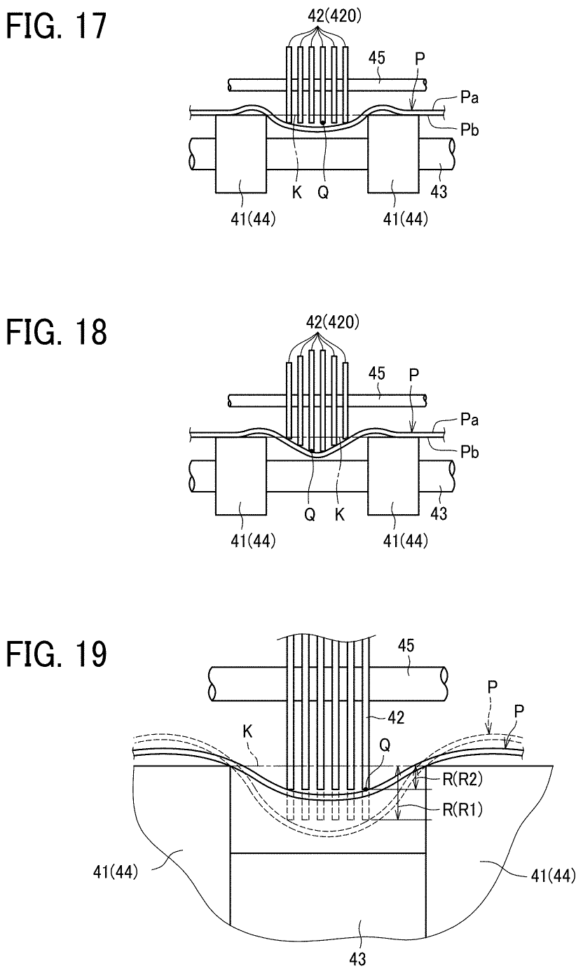

FIG. 17 is a diagram illustrating rollers 41 disposed on the support shaft 43 and the group of spurs 420 disposed on the support shaft 45 in which the group of spurs 420 enters an area between the rollers 41, according to one of the above embodiments of the present disclosure.

In this case, a tip end Q of each of the spurs 42 in the outer diameter direction is disposed so as to enter into an inner diameter of the roller 41 close to the support shaft 43 from a position K of the outer peripheral surface of the roller 41. Thus, the sheet P can be conveyed while being curved by the roller 41 and the spurs 42. Accordingly, in the embodiment illustrated in FIG. 17, even when cockling or waving of the sheet P occurs, the sheet P is bent and conveyed in a direction opposite to a direction in which the sheet P is cockled. Thus, the cockling of the sheet P can be corrected.

FIG. 18 is a diagram illustrating rollers 41 disposed on the support shaft 43 and the group of spurs 420 disposed on the support shaft 45 in which the projecting amount of the spurs 42 between the rollers 41 changes in the axial direction of the support shaft 45, according to one of the above embodiments of the present disclosure.

In the embodiment illustrated in FIG. 18, the position of the tip end Q of each one of the spurs 42 in the outer diameter direction is different. In this case, the amount in which the tip end Q of each one of the spurs 42 enters from the position K of the outer peripheral surface of the roller 41 changes gently in a curved shape over the axial direction. Accordingly, the curvature of the sheet P bent by the roller 41 and the spurs 42 can be made gentle and small. Thus, the load on the sheet P can be reduced, and damage to the sheet P and deterioration in image quality can be prevented.

FIG. 19 is a diagram illustrating the rollers 41 disposed on the support shaft 43 and the spurs 42 disposed on the support shaft 45 in which a projecting amount R of the spurs 42 between the rollers 41 changes in the axial direction of the support shaft 45, according to one of the above embodiments of the present disclosure.

As illustrated in FIG. 19, changing the projecting amount R of the tip Q of each one of the spurs 42 allows the contact pressure and the conveyance force of the spurs 42 with respect to the sheet P to be adjusted. In other words, when the projecting amount R of the tip end Q of each one of the spurs 42 is large, i.e., when the projecting amount is R1, the bending amount of the sheet P is larger than when the projecting amount R is small, i.e., when the entering amount is R2. Thus, the sheet holding power by the roller 41 and the spurs 42 is increased. Accordingly, the force for conveying the sheet P is increased, and the conveyance performance is enhanced. On the other hand, when the projecting amount R of the spurs 42 is small, the contact pressure of the spurs 42 with respect to the sheet P can be reduced. For this reason, making the projecting amount R of the spurs 42 in the upstream portion smaller than the projecting amount R of the spurs 42 in the downstream portion allows to reduce the contact pressure of the spurs 42 in the upstream portion and to prevent contact marks of the spurs 42 and the disturbance of image.

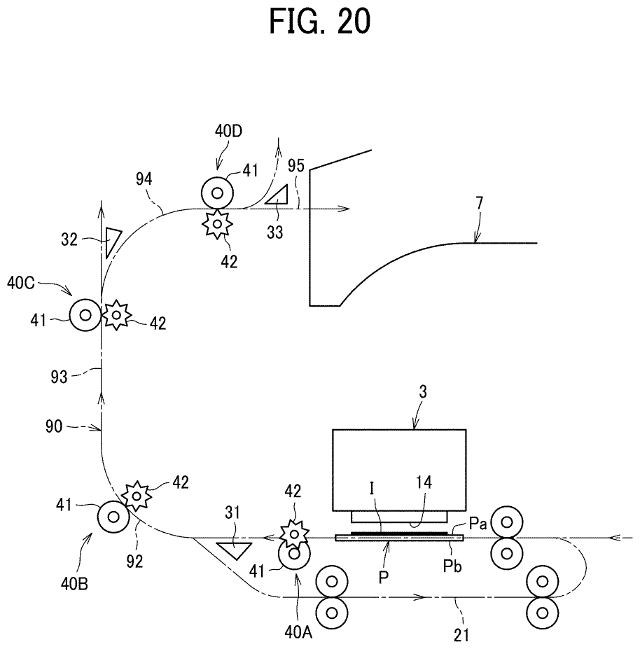

FIG. 20 is a diagram illustrating the conveyance path 90 in which both pairs of the roller 41 and the spurs 42 that are in contact with each other and pairs of the roller 41 and the spurs 42 that are not in contact with each other are disposed, according to one of the above embodiments of the present disclosure.

As in the embodiment described with reference to FIG. 20, each of the first conveyor 40A, the second conveyor 40B, the third conveyor 40C, and the fourth conveyor 40D disposed in the conveyance path 90 may be either a conveyor such as the first conveyor 40A, having the roller 41 and the spurs 42 that are in contact with each other or a conveyor such as the second conveyor 40B, the third conveyor 40C, or the fourth conveyor 40D, having the roller 41 and the spurs 42 that are not in contact with each other.

FIG. 21 is a diagram illustrating the groups of spurs 420 disposed on the support shafts 45 in which each of the multiple spurs 42 disposed on one of the support shafts 45 contacts a corresponding one of the spurs 42 disposed on the other support shaft 45 via the sheet P, according to one of the above embodiments of the present disclosure.

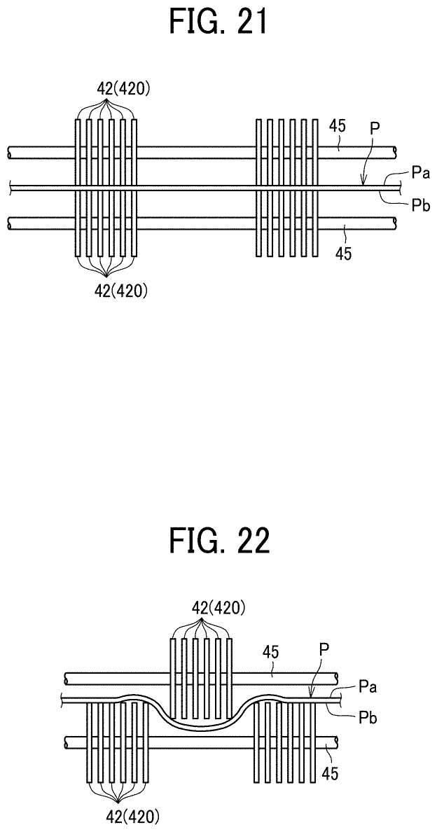

FIG. 22 is a diagram illustrating the groups of spurs 420 disposed on the support shafts 45 in which the multiple spurs 42 disposed on one of the support shafts 45 does not contact the multiple spurs disposed on the other support shaft 45 via the sheet P, according to one of the above embodiments of the present disclosure.

The conveyor may be a conveyor in which the spurs 42 are in contact with each other as illustrated in FIG. 21, or another conveyor in which the spurs 42 are arranged to be shifted from each other in the axial direction as illustrated in FIG. 22.

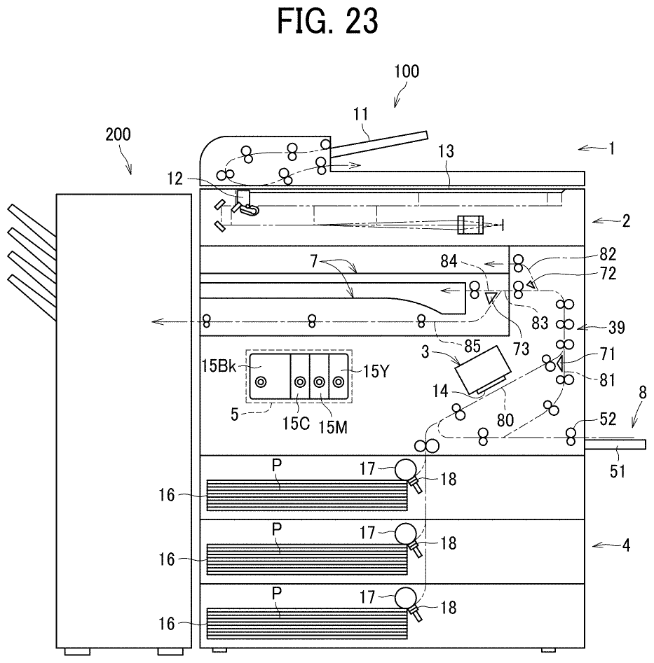

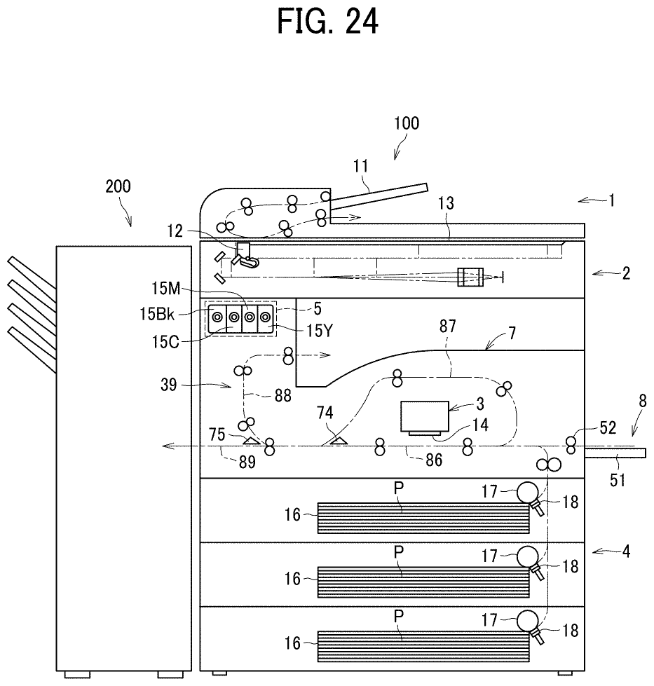

The image forming apparatus 100 on which the conveyance device 39 according to the present disclosure is mounted is not limited to the image forming apparatus 100 illustrated in FIG. 1, and the embodiments of the present disclosure can be applied to, for example, the image forming apparatus 100 illustrated in FIG. 23 or 24.

Other image forming apparatuses according to alternative embodiments of the present disclosure are described in the following description. In each of the image forming apparatuses described below, portions different from those of the above-described embodiment are mainly described, and other portions are the same as those of the above-described embodiments. Thus, description thereof is omitted.

FIG. 23 is a diagram illustrating the image forming apparatus 100 according to a further alternative embodiment of the present disclosure.

FIG. 24 is a diagram illustrating the image forming apparatus 100 according to a further alternative embodiment of the present disclosure.

The image forming apparatus 100 illustrated in FIG. 23 includes a document conveyance device 1, an image reading device 2, an image forming device 3, a sheet feeder 4, a cartridge holder 5, a conveyance device 39, and upper and lower sheet output trays 7 that are similar as described in the above embodiments. In addition, the image forming apparatus 100 illustrated in FIG. 23 further includes a bypass sheet feeder 8. Different from the image forming device 3 in FIG. 1, the image forming device 3 in FIG. 20 is disposed facing a conveyance path 80 in which the sheet P is conveyed in a direction obliquely to the horizontal direction.

The bypass sheet feeder 8 includes a manual feed tray 51 that serves as a placement unit on which the sheets P are placed, and a sheet feed roller 52 that serves as a feeding unit that feeds the sheets P from the manual feed tray 51. The manual feed tray 51 is attached to the body of the image forming apparatus 100 in an openable and closable manner or in a swingable manner. When the manual feed tray 51 is opened as illustrated in FIG. 23, a sheet P can be placed on the manual feed tray 51 and fed.

In the image forming apparatus 100 illustrated in FIG. 23, when a print job start instruction is issued, the sheet P is supplied from the sheet feeder 4 or from the bypass sheet feeder 8 and is conveyed to the image forming device 3 by the conveyance device 39. When the sheet P is conveyed to the image forming device 3, ink is discharged from the liquid discharge head 14 onto the sheet P to form an image.

When double-sided printing is performed, after the sheet P passes through the image forming device 3, the sheet P is conveyed in the opposite direction and guided to the reverse conveyance path 81 by the first path switching unit 71. Then, the sheet P passes through the reverse conveyance path 81 to be turned upside down. Then, the sheet P is conveyed to the image forming device 3 again and an image is formed on the back surface of the sheet P.

The sheet P on one side or both sides of which an image has been formed is conveyed further downstream by the conveyance device 39 through the first path switching unit 71. The sheet P is selectively guided by the second path switching unit 72 to the conveyance path 82 that leads to the upper sheet output tray 7 or the conveyance path 83 that leads to the lower sheet output tray 7. When the sheet P is guided to the conveyance path 82 toward the upper sheet output tray 7, the sheet P is ejected to the upper sheet output tray 7. On the other hand, when the sheet P is guided to the conveyance path 83 toward the lower sheet output tray 7, the third path switching unit 73 selectively guides the sheet P to the conveyance path 84 toward the lower sheet output tray 7 or the conveyance path 85 toward the sheet alignment apparatus 200.

When the sheet P is guided to the conveyance path 84 toward the lower sheet output tray 7, the sheet P is ejected to the lower sheet output tray 7. On the other hand, when the sheet P is guided to the conveyance path 85 toward the sheet alignment apparatus 200, the sheet P is conveyed to the sheet alignment apparatus 200, so that the bundle of sheets P is aligned and stacked.

Next, similar to the image forming apparatus 100 illustrated in FIG. 23, the image forming apparatus 100 illustrated in FIG. 24 includes a document conveyance device 1, an image reading device 2, an image forming device 3, a sheet feeder 4, a cartridge holder 5, a conveyance device 39, a sheet output tray 7, and a bypass sheet feeder 8. In this case, similar to the embodiment illustrated in FIG. 1, the image forming device 3 is disposed so as to face the conveyance path 80 along which the sheet P is conveyed in the horizontal direction.

In the image forming apparatus 100 illustrated in FIG. 24, when a print job start instruction is issued, the sheet P is supplied from the sheet feeder 4 or from the bypass sheet feeder 8 and is conveyed to the image forming device 3 by the conveyance device 39. When the sheet P is conveyed to the image forming device 3, ink is discharged from the liquid discharge head 14 onto the sheet P to form an image.

When double-sided printing is performed, after the sheet P has passed through the image forming device 3, the sheet P is conveyed in the opposite direction, and is guided to the reverse conveyance path 87 by the first path switching unit 74. Then, as the sheet P passes the reverse conveyance path 87, the sheet P is turned upside down and is conveyed to the image forming device 3 again, so that an image is formed on the back face of the sheet P.

The sheet P on one side or both sides of which an image has been formed is conveyed further downstream by the conveyance device 39 through the first path switching unit 74. Then, the sheet P is selectively guided by the second path switching unit 75 to the conveyance path 88 toward the sheet output tray 7 or the conveyance path 89 toward the sheet alignment apparatus 200. When the sheet P is guided to the conveyance path 88 toward the sheet output tray 7, the sheet P is ejected to the sheet output tray 7. On the other hand, when the sheet P is guided to the conveyance path 89 toward the sheet alignment apparatus 200, the sheet P is conveyed to the sheet alignment apparatus 200, so that the bundle of sheets P is aligned and stacked.

Also in the conveyance device 39 mounted on the image forming apparatus 100 illustrated in FIG. 23 or 24, the same operation and effect can be obtained by adopting the configuration of the above-described embodiment. In other words, image quality and conveyance performance can be ensured while preventing an increase in the number of spurs 42. Thus, the apparatus cost and the assembly man-hours can be reduced.

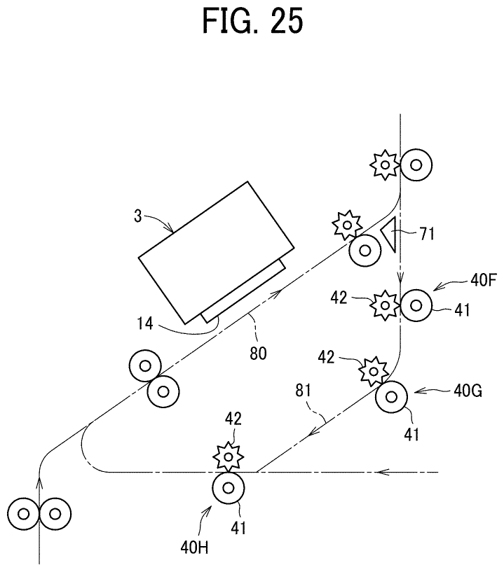

FIG. 25 is a diagram illustrating a reverse conveyance path 81 provided for the image forming apparatus 100, according to an embodiment of the present disclosure.

The embodiments of the present disclosure is not limited to the conveyance paths that convey the sheet P from the image forming device 3 to the sheet output tray 7, and can also be applied to the reverse conveyance path 81 that reverses the sheet P and conveys the reversed sheet P to the image forming device 3. In the reverse conveyance path 81, the trailing edge of a sheet P on which an image has just been formed enters as the leading edge of the sheet P due to the switchback operation, i.e., conveyance in the opposite direction, of the sheet P. Thus, when the spurs 42 strongly contact the leading edge of the sheet P after the switchback operation, there is a possibility that contact marks of the spurs 42 are formed on the sheet P or the image is disturbed.

Accordingly, as illustrated in FIG. 25, in the reverse conveyance path 81, desirably the contact pressure between the roller 41 and the spurs 42 decreases in order from a most downstream conveyor 40H to upstream conveyors 40G and 40F. In a case in which the roller 41 and the spurs 42 are not in contact with each other, the projecting amount R (see FIG. 19) of the spurs 42 may be decreased in order from the most downstream conveyor 40H to the upstream conveyors 40G and 40F. Such a configuration as described above allows to prevent the generation of contact marks due to the spurs 42 coming into contact with the sheet P. Similar to each of the above-described embodiments, a decrease in conveyance performance due to a decrease in the contact pressure of the spurs 42 in the upstream portion relative to the downstream portion of the conveyance path can be compensated for by increasing the number of spurs 42 on the upstream portion relative to the number of spurs 42 on the downstream portion. Thus, conveyance performance can be secured. For example, the number of spurs 42 may increase in order from the most downstream conveyor 40H to the upstream conveyors 40G and 40F.

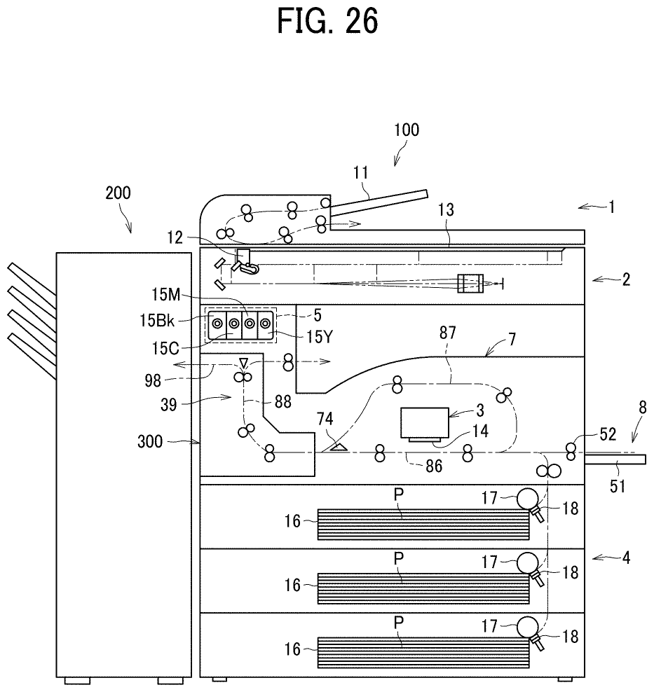

FIG. 26 is a diagram illustrating a conveyance device 300 provided for the image forming apparatus 100, according to an alternative embodiment of the present disclosure.

The embodiments of the present disclosure is not limited to the conveyance device 39 provided integrally with the body of the image forming apparatus 100, and can also be applied to a conveyance device such as the conveyance device 39 that can be attached to and detached from the body of the image forming apparatus 100. In FIG. 26, the conveyance device 300 that includes a conveyance device 39, according to the present alternative embodiment of the present disclosure, is illustrated.

The conveyance device 300 illustrated in FIG. 26 includes conveyance paths 88 and 98 that convey a sheet P on which an image has been formed to a post-processing unit such as the sheet alignment apparatus 200, and is attachable to and detachable from the body of the image forming apparatus 100.

Also in the conveyance device 300, adopting the configuration according to the above-described embodiment allows to secure image quality and conveyance performance while preventing an increase in the number of spurs 42. Thus, the apparatus cost and the assembly man-hours can be reduced.

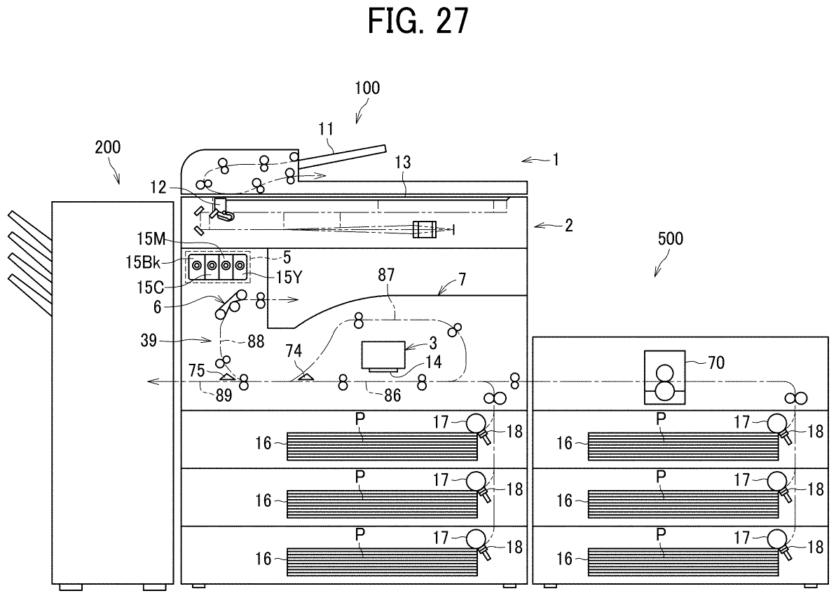

FIG. 27 is a diagram illustrating a liquid discharging apparatus according to an alternative embodiment of the present disclosure.

The embodiments of the present disclosure are not limited to the conveyance device 39 provided for the image forming apparatus 100, and can also be applied to a liquid discharge device that discharges, for example, a processing liquid that does not form an image.

The liquid discharging apparatus illustrated in FIG. 27 includes, in addition to the image forming apparatus 100, a treatment liquid discharge apparatus 500 that discharges a treatment liquid for modifying the surface of a sheet P before image formation. The treatment liquid discharge apparatus 500 includes a liquid discharge unit 70 as a treatment liquid discharger that discharges a treatment liquid onto a sheet P. In this case, after the treatment liquid is discharged onto the sheet P from the liquid discharge unit 70 of the treatment liquid discharge apparatus 500, the sheet P is conveyed to the image forming apparatus 100. After an image has been formed on the sheet P in the image forming device 3, the sheet P is conveyed to the drying device 6 by the conveyance device 39 that includes, for example, spurs 42, conveyance rollers and the drying device 6 performs drying process of ink on the sheet P. The liquid discharge apparatus may include a drying device in the treatment liquid discharging apparatus 500. In this case, after the treatment liquid has been applied to the sheet P by the treatment liquid discharge apparatus 500, the treatment liquid on the sheet P is dried by the drying device in the treatment liquid discharge apparatus 500, and the sheet P is conveyed to the image forming apparatus 100.

Also in the conveyance device 39 provided for the above-described liquid discharge apparatus, adopting the above-described configuration of the embodiment allows to secure image quality and conveyance performance while preventing an increase in the number of spurs 42. Thus, the apparatus cost and the assembly man-hours can be reduced.

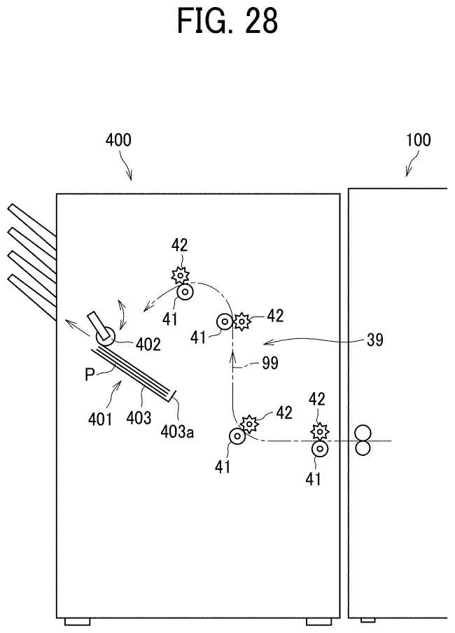

FIG. 28 is a diagram illustrating a post-processing apparatus 400 according to an embodiment of the present disclosure.

The embodiments of the present disclosure can also be applied to a post-processing apparatus that performs post-processing on a sheet P on which an image has been formed.

The post-processing apparatus 400 illustrated in FIG. 28 includes the conveyance device 39 that conveys a sheet P and a post-processing device 401 that performs post-processing such as stapling or punching on the sheet P. As the sheet P is conveyed from the image forming apparatus 100 to the post-processing apparatus 400 illustrated in FIG. 28, the sheet P is conveyed by the conveyance device 39 and is placed on a sheet stacking tray 403 of the post-processing device 401. At this time, when the sheet P is placed in the sheet stacking tray 403 with the surface of the sheet P on which an image is formed facing upward, the order of image formation may be set to be reversed, in other words, the image may be formed from the last page first. The sheet P placed on the sheet stacking tray 403 is conveyed in a front-rear reverse direction by a conveyance roller 402 disposed in the post-processing device 401. Such a configuration as described above allows the trailing end of the sheet P to contact a trailing end regulator 403a of the sheet stacking tray 403. Thus, the position of the trailing ends of the sheets P are aligned. The conveyance roller 402 is movable from a position at which the conveyance roller 402 can contact the sheet P to a retreat position at which the conveyance roller 402 does not contact the sheet P so as not to hinder the discharge of the sheet P to the sheet stacking tray 403. Then, in a state in which the trailing ends of the sheets P are aligned, for example, stapling or punching is performed on the sheets P. Thereafter, the conveyance roller 402 rotates in the reverse direction. Accordingly, the sheet P on the sheet stacking tray 403 is ejected to the outside of the post-processing apparatus 400.

Also in the conveyance device 39 provided for the post-processing apparatus 400, adopting the same configuration as that of the above-described embodiment allows to secure image quality and conveyance performance while preventing an increase in the number of spurs 42. Thus, the apparatus cost and assembly man-hours can be reduced.

In the embodiments of the present disclosure, the sheet P to which liquid is adhered may be, for example, a sheet to which liquid can be adhered at least temporarily, a sheet to which liquid is adhered and fixed, or a sheet to which liquid is adhered and penetrated. Specifically, the sheet includes not only a paper sheet but also, for example, a resin film, wallpaper, and an electronic substrate. Examples of the material of the sheet include paper, leather, metal, plastic, glass, wood, and ceramics. The sheet to which the liquid adheres may be cut sheet that has been cut into a predetermined size in the sheet conveyance direction in advance, or may be long roll sheet that has been wound into a roll shape.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A conveyance device comprising:
a plurality of pairs of rotators including:
a plurality of first rotators disposed adjacent to a reverse side of a liquid-adhered surface of a sheet to which liquid is adhered; and
a plurality of second rotators disposed adjacent to the liquid-adhered surface of the sheet, the plurality of second rotators having a plurality of protrusions that radially stick out,
each one of the plurality of pairs of rotators including one of the plurality of first rotators and two or more of the plurality of second rotators; and
a conveyance path through which the sheet is conveyed, the conveyance path including at least one curved conveyance portion,
wherein the plurality of pairs of rotators are disposed at intervals on the conveyance path in a conveyance direction,
wherein the one of the plurality of first rotators and the two or more of the plurality of second rotators in at least one of the plurality of pairs are disposed in contact with each other, and
wherein a number of the two or more of the plurality of second rotators arranged in a sheet width direction perpendicular to the conveyance direction is larger in an upstream portion than in a downstream portion of the conveyance path in the conveyance direction.

2. The conveyance device according to claim 1,
wherein the one of the plurality of first rotators and the two or more of the plurality of second rotators in one of the plurality of pairs are in contact with each other, and
wherein the one of the plurality of first rotators and two or more of the plurality of second rotators in another one of the plurality of pairs are not in contact with each other.

3. The conveyance device according to claim 1,
wherein the two or more of the plurality of second rotators in one of the plurality of pairs are disposed at different positions in the sheet width direction between the upstream portion and the downstream portion.

4. The conveyance device according to claim 1,
wherein a contact pressure between the one of the plurality of first rotators and the two or more of the plurality of second rotators in one of the plurality of pairs is different between the upstream portion and the downstream portion.

5. The conveyance device according to claim 1,
wherein a thickness of one of the plurality of second rotators in the sheet width direction is different between the upstream portion and the downstream portion.

6. The conveyance device according to claim 1,
wherein a number of the plurality of protrusions of one of the plurality of second rotators is different between the upstream portion and the downstream portion.

7. The conveyance device according to claim 1,
wherein the plurality of second rotators are disposed in the upstream portion, the downstream portion, and a midstream portion between the upstream portion and the downstream portion of the conveyance path in the conveyance direction, and
wherein the number of the two or more of the plurality of second rotators arranged in the sheet width direction is larger in each of the upstream portion and the midstream portion than in the downstream portion.

8. The conveyance device according to claim 1,
wherein the plurality of second rotators are disposed in the upstream portion, the downstream portion, and a midstream portion between the upstream portion and the downstream portion of the conveyance path in the conveyance direction, and
wherein the number of the two or more of the plurality of second rotators arranged in the sheet width direction is larger in the midstream portion than in the downstream portion,
wherein the number of the two or more of the plurality of second rotators arranged in the sheet width direction is larger in the upstream portion than in the midstream portion.

9. The conveyance device according to claim 1,
wherein the plurality of second rotators are disposed in the upstream portion, the downstream portion, and a midstream portion between the upstream portion and the downstream portion of the conveyance path in the conveyance direction,
wherein the number of the two or more of the plurality of second rotators arranged in the sheet width direction is larger in the downstream portion than in the midstream portion, and
wherein the number of the two or more of the plurality of second rotators arranged in the sheet width direction is larger in the upstream portion than in the downstream portion.

10. The conveyance device according to claim 1,
wherein the plurality of second rotators are disposed in the upstream portion, the downstream portion, and a midstream portion between the upstream portion and the downstream portion of the conveyance path in the conveyance direction, and
wherein a contact pressure between the one of the plurality of first rotators and the two or more of the plurality of second rotators in one of the plurality of pairs is different among the downstream portion, the upstream portion, and the midstream portion.

11. A liquid discharging apparatus comprising:
the conveyance device according to claim 1; and
a liquid discharger configured to discharge the liquid onto the sheet.

12. An image forming apparatus comprising:
the conveyance device according to claim 1; and
an image forming device configured to discharge the liquid onto the sheet to form an image.

13. A post-processing apparatus comprising:
the conveyance device according to claim 1; and
a post-processing device configured to perform post-processing to the sheet.

14. The conveyance device according to claim 1, further comprising another conveyance path through which the sheet is conveyed to a post-processing device configured to perform post-processing to the sheet.

15. A conveyance device comprising:
a plurality of pairs of rotators including:
a plurality of first rotators disposed adjacent to a reverse side of a liquid-adhered surface of a sheet to which liquid is adhered;
a plurality of second rotators disposed adjacent to the liquid-adhered surface of the sheet, each one of the plurality of second rotators having a plurality of protrusions that radially stick out;
each one of the plurality of pairs including one of the plurality of first rotators and two or more of the plurality of second rotators; and
a conveyance path through which the sheet is conveyed, the conveyance path including at least one curved conveyance portion,
wherein the plurality of pairs of rotators are disposed at intervals on the conveyance path in a conveyance direction,
wherein the one of the plurality of first rotators and the two or more of the plurality of second rotators in at least one of the plurality of pairs are spaced apart from each other in a sheet width direction perpendicular to the conveyance direction, and
wherein a number of the two or more of the plurality of second rotators arranged in the sheet width direction is larger in an upstream portion than in a downstream portion of the conveyance path in the conveyance direction.
